(19) United States
(12) Patent Application Publication
(10) Pub. No.: US 2004/0129540 A1
(43) Pub. Date: Jul. 8, 2004

(54) Transport system, in particular high-speed baggage handling system

(75) Inventors: Wolfgang Brixius, Neunkirchen A.Br. (DE); Dominik Graefer, Nurnberg (DE); Albrecht Hoene, Herzogenaurach (DE)

Correspondence Address: Henry M. Feiereisen, Suite 4714, 350 Fifth Avenue, New York, NY, 10118, US

(73) Assignee: SIEMENS AKTIENGESELLSCHAFT, Munchen (DE)

(21) Appl. No.: 10/683,555

(22) Filed: Oct. 10, 2003

(30) Foreign Application Priority Data
Oct. 11, 2002 (DE) 202 15 627.3

(51) Int. Cl. B65G 21/00

(52) U.S. Cl. 198/860.2

(57) ABSTRACT

A transport system, in particular high-speed baggage handling system for airports, includes a plurality of individual conveyors of modular configuration, which are driven and placed in succession to define a transport path, and a coupling mechanism for coupling conveyors to form a mechanical unitary structure.

### CROSS-REFERENCES TO RELATED APPLICATIONS

This application claims the priority of German Patent Application, Serial No. 202 15 627.3, filed Oct. 11, 2002, pursuant to 35 U.S.C. 119(a)-(d), the disclosure of which is incorporated herein by reference.

### BACKGROUND OF THE INVENTION

The present invention relates to a transport system, in particular a high-speed baggage handling system in airports.

An exemplified conventional transport system of this type is shown in FIG. 1 and includes a plurality of conveyors 1 which are placed in succession to form a transport path, as indicated by arrow T, for conveying articles A. Each of the conveyors 1 includes a belt 2 which is guided around two spaced-apart pulleys 3, whereby one of the pulleys 3 is driven by a motor M, normally an asynchronous motor. A basic problem arises, when using asynchronous motors as drives for the conveyors, because the rotation speed of such drives is dependent on the load. As a consequence, the transport velocity is dependent on the weight of the conveyed articles. In other words, the distance between successive articles changes during transfer from one conveyor to a next conveyor, when the articles have different weights. The shift of articles relative to one another cannot be predicted because their weight is normally unknown so that this phenomenon represents a safety concern which adversely affects the effectiveness of such a transport system.

The change in distance between successive articles of different weight during their transport is especially a problem, when the transport path is very long. This is the case, e.g. in high-speed baggage sorters for airports, where baggage articles are transported at speeds of 7 m/s and more over several hundred meters. Thus, lighter baggage will ultimately catch up with heavy baggage, leading to collisions between slower leading bags and faster trailing bags. Evidently, the longer the transport path and the greater the weight difference between successive articles, the greater the problem.

To address these shortcomings, several approaches have been proposed to date. One approach involves a speed feedback in which the motor speed or the belt speed is measured and deviations from the desired variable are compensated. This approach complicates the overall system in view of the added measuring technique and controllers.

Another approach suggests the use of servo drives having a characteristic curve which is so steep that differences in speed become negligible. Also this approach complicates the overall transport system. Still another approach proposes the provision of synchronous machines. In this case, the rotor displacement angle, i.e. the rotor position, has to be known for operation of synchronous machines. While the rotation speed is hereby in synchronism with the set point, there is a need for a feedback of the rotor position, thereby also complicating the overall system. An alternative proposal involves the provision of electronically commutated d.c. motors. Also this proposal requires knowledge of the rotor position for commutation.

It would therefore be desirable and advantageous to provide an improved transport system which obviates prior art shortcomings and which is simple in structure and cost-efficient while yet reliable in operation.

### SUMMARY OF THE INVENTION

According to one aspect of the present invention, a transport system, in particular high-speed baggage handling system in airports includes a plurality of driven individual conveyors of modular configuration, wherein the conveyors are placed in succession to define a transport path, and a coupling mechanism for coupling conveyors to form a mechanical unitary structure.

According to another feature of the present invention, the coupling mechanism may include a plurality of coupling belts, wherein each coupling belt is adapted for pairing neighboring conveyors. Suitably, the conveyor belt is guided about adjacent pulleys of neighboring conveyors. The provision of coupling belts to link the conveyors is cost-efficient and simple. As each single conveyor is constructed as a module and includes the required connection elements (pulleys or rollers or the like), any desired number of individual conveyors can be combined to a mechanical unitary structure of randomly long transport path at the job site. Thus, a modular system is realized that decreases manufacturing costs but in addition significantly reduces the assembly time.

As an alternative, the coupling mechanism may also be realized through a chain drive or spur gear mechanism for pairing neighboring conveyors.

According to another feature of the present invention, the mechanical unitary structure includes at least three single conveyors, preferably more than ten individual conveyors. Suitably, each mechanical unitary structure may be formed by conveyors that are driven directly or indirectly. The term “directly” refers hereby to the fact that each driven conveyor has its own drive motor, whereas the term “indirectly” refers to conveyors which lack the provision of a separate motor and are driven by the motor of the neighboring conveyors. The number of directly driven conveyors depends on their length and the loads being transported. Tests have shown that at least every third conveyor, preferably every other conveyor, of the unitary structure should include a motor for directly propelling the conveyor in transport direction.

According to another feature of the present invention, the motor is an asynchronous motor.

According to another feature of the present invention, there may be provided transfer conveyors disposed upstream and downstream of each mechanical unitary structure to load the mechanical unitary structure with single articles, e.g. bags, at predetermined distances and thus to operate as buffer that allows an acceleration or slow down of the transport speed between following modular unitary structures so that the distances between successive articles is maintained along the entire transport path.

The provision of a modular transport handling system according to the present invention is especially suitable for use as high-speed sorter of baggage handling systems in airports at speeds of equal to greater than 5 m/s.

The present invention resolves prior art problems by combining single conveyors to a unitary structure so that long distances can be covered at high speed, without encountering a bunching up or backup of articles such as bags. Distances between successive articles are maintained and can be set by suitable feed belts. The entire mass inertia maintains a constant speed and includes all those transport articles that are located on the coupled unitary structure at any given time as well as all belts, transmissions, pulleys and any other masses that rotate or are moved translationally. The transport path can be configured of any desired length and the need for sensors is reduced because long conveyors require less sensor technology, e.g. light barriers, compared to the provision of many short conveyors. Heavier articles have no significant impact on the transport as the load is distributed over many drives. Thus, even when a drive shuts down during operation, the overall transport system will not be adversely affected in view of the built-in redundancy. In other words, the breakdown of a drive can be compensated by the other drives.

A further advantage of the present invention is the ability to exploit the overall capacity of the drives for measures that increase the speed, for example. Re-starting of the transport system is significantly simplified because the transport system is, in effect, a single conveyor belt, with the drives operated in synchronism in a same manner. Also the provision of coupling belts is cost-efficient

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 is a simplified schematic illustration of a conventional transport system;

FIG. 2 is a simplified schematic illustration of a transport system according to the present invention; and

FIG. 3 is a simplified schematic illustration of a modified transport system according to the present invention.

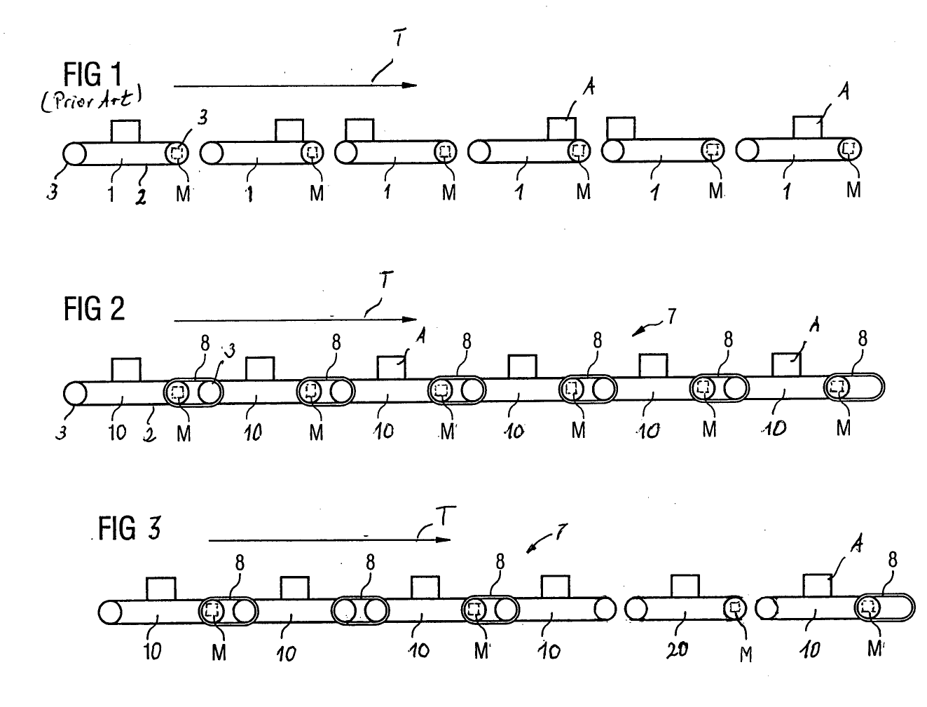

### DETAILED DESCRIPTION OF PREFERRED EMBODIMENTS

Throughout all the Figures, same or corresponding elements are generally indicated by same reference numerals. These depicted embodiments are to be understood as illustrative of the invention and not as limiting in any way. It should also be understood that the drawings are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

Turning now to FIG. 2, there is shown a simplified schematic illustration of an art handling transport system according to the present invention, generally designated by reference numeral 7. The transport system 7, used for example for handling baggage in airports, includes a plurality of conveyors 10 which are placed in succession to form a transport path, as indicated by arrow T, for articles A. The conveyors 10 are of modular configuration and may be of identical design, or may have a different length. Each of the conveyors 10 includes a belt 2 which is guided around two-spaced-apart pulleys 3, whereby one of the pulleys 3 is driven by a motor M, e.g. an asynchronous motor. The motors M may be operated via converters in such a manner that the torque between the motors M is appropriately distributed. While FIG. 2 shows each conveyor 10 with one of its pulleys 3 being motor-driven, it will be appreciated by persons skilled in the art that such a configuration is shown by way of example only. It is, of course, conceivable to directly drive only at least every third one of the conveyors 10, preferably every second one of the conveyors 10, as shown by way of example in FIG. 3.

As shown in FIG. 2, the conveyors 10 are connected to one another by coupling belts 8 by which the motor-driven pulley 3 of one of the conveyors 10 is coupled to the adjacent idler pulley 3 of the neighboring conveyor 10. In this way, the conveyors 10 are paired to form a mechanical unitary structure. It will be understood by persons skilled in the art that FIG. 2 depicts only an exemplified configuration of the transport system in which six conveyors 10 are combined. It is, of course, conceivable, and indeed currently preferred, to couple more than ten conveyors 10 to a unitary structure. In any event, at least three conveyors 10 should be combined to a unitary structure.

Although the provision of coupling belts 8 as coupling mechanism is a currently preferred embodiment, it is, of course, also conceivable to connect neighboring conveyors via chain drives or via spur gears.

Thus, by combining a random number of conveyors 10 to a mechanical unitary structure, a resultant transport system may be extended to any desired length by arranging a number of such transport modules, each comprised of conveyors 10 combined to a unitary structure.

FIG. 3 shows a simplified schematic illustration of a modified transport system according to the present invention. Parts corresponding with those in FIG. 2 are denoted by identical reference numerals and not explained again. In this embodiment, provision is made for a transfer conveyor 20 which is disposed upstream and downstream of each mechanical unitary structure 7 to load the mechanical unitary structure 7 with single articles A, e.g. bags, at predetermined distances and thus to operate as buffer that allows an acceleration or slow down of the transport speed so that the distances between successive articles A along the entire transport path is maintained.

Coupling of individual conveyors 10 does not adversely affect the control mechanism for the transport system, as the control mechanism considers the high-speed transport system as a block which can be halted as a unit in case of a backup. On the other, a restart of the transport system can be implemented rapidly and easily after a problem has been encountered.

While the invention has been illustrated and described in connection with currently preferred embodiments shown and described in detail, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and their equivalents:

What is claimed is:

1. A transport system, in particular high-speed baggage handling system for airports, comprising a plurality of driven individual conveyors of modular configuration, said conveyors being placed in succession to define a transport path; and a coupling mechanism for coupling conveyors of the plurality of conveyors to form a mechanical unitary structure.

2. The transport system of claim 1, wherein the mechanical unitary structure includes at least three of said conveyors.

3. The transport system of claim 1, wherein the mechanical unitary structure includes more than ten of said conveyors.

4. The transport system of claim 1, wherein the plurality of conveyors includes a first group of conveyors and a second group of conveyors, wherein each of the conveyors of the first group includes a drive for direct propulsion of the conveyor, wherein the conveyors of the second group of conveyors are indirectly propelled.

5. The transport system of claim 1, wherein at least every third conveyor of the plurality of conveyors includes a motor for propelling the conveyor in transport direction.

6. The transport system of claim 1, wherein every second conveyor of the plurality of conveyors includes a motor for propelling the conveyor in transport direction.

7. The transport system of claim 5, wherein the motor is an asynchronous motor.

8. The transport system of claim 1, and further comprising a transfer conveyor disposed upstream or downstream of the mechanical unitary structure to operate as acceleration and deceleration path.

9. The transport system of claim 1, wherein the coupling mechanism includes a plurality of coupling belts, each coupling belt adapted for pairing neighboring conveyors.

10. The transport system of claim 9, wherein each of conveyors includes two spaced-apart pulleys and a belt guided abound the pulleys, wherein adjacent pulleys of neighboring conveyors are paired by the coupling belt.

11. The transport system of claim 1, wherein the coupling mechanism includes a plurality of chain drives, each chain drive adapted for pairing neighboring conveyors.

12. The transport system of claim 1, wherein the coupling mechanism includes a plurality of spur gear mechanisms, each spur gear mechanism adapted for connecting neighboring conveyors.

13. The transport system of claim 1, wherein the mechanical unitary structure is constructed as a high-speed transport sorter in an airport for operation at speeds of equal or greater than 5 m/s.
